(19) United States
(12) Patent Application Publication
(10) Pub. No.: US 2024/0028416 A1
(43) Pub. Date: Jan. 25, 2024

(54) Centralized Management of External Clusters on Managed Kubernetes Platforms

(71) Applicant: Dell Products L.P., Round Rock, TX (US)

(72) Inventors: David JENSEN, Dallas, TX (US); Linwood W. ZOLLER, IV, Lexington, KY (US); Daniel E. CUMMINS, Hudson, NH (US)

(73) Assignee: Dell Products L.P., Round Rock, TX (US)

(21) Appl. No.: 17/867,729

(22) Filed: Jul. 19, 2022

(51) Int. Cl. G06F 9/50; G06F 9/445; G06F 21/60

(52) U.S. Cl. CPC G06F 9/5077; G06F 9/44505; G06F 21/604; G06F 2209/505

(57) ABSTRACT

A method for managing remote Kubernetes clusters employs a central orchestrator with cluster integration interfaces for one or more managed Kubernetes platforms. A cluster of interest is selected via one of the interfaces and a connection with the applicable platform is registered. The registered connection may include platform account credentials and cluster admin role information to an authenticated cluster-admin role defined for the platform. A platform-specific microservice (PSM), provisioned with platform-specific logic and tooling, is instantiated. The PSM retrieves an administrative manifest including one or more administrative pods enabling the central orchestrator to communicate securely with the platform and deploy and manage application workloads on the cluster. The cluster of interest is then imported into the central orchestrator enabling administrators to perform platform-specific management tasks, including cluster infrastructure configuration tasks such as scaling nodes, updating Kubernetes versions, and modifying access/permission roles.

### TECHNICAL FIELD

The present disclosure relates to containerized information handling resources and, more particularly, management of such resources.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Kubernetes has become a very common application platform. To support the large number of applications built on top of Kubernetes, centralized, external cluster management systems must be able to integrate with existing Kubernetes clusters. However, many deployments of Kubernetes are based on vendor-specific implementations, which include not only the Kubernetes core functionality, but also the vendor's platform tools and features. Each of these varied implementations require unique logic and, typically, tooling to manage the cluster infrastructure that supports the Kubernetes implementation. Thus, while conventional Kubernetes cluster management systems permit users to manage the Kubernetes implementation, deploy container-based workloads, and work with Kubernetes-based tools such as kubectl, they do not enable IT administrators to centrally manage external Kubernetes cluster infrastructure.

This deficiency prevents IT administrators from, as examples, scaling cluster infrastructure, either horizontally or vertically and performing Kubernetes version updates. The cluster software has no information about the infrastructure of the hosting platform upon which it is running, thereby eliminating any possibility of the software taking advantage of any platform-specific features and functionality. Instead, the hosting platform is effectively a black box from the software's perspective.

### SUMMARY

In accordance with teachings disclosed herein, common problems associated with conventional Kubernetes management solutions, including issues identified in the preceding paragraphs, are addressed by systems and methods disclosed herein.

In one aspect, teachings set forth herein disclose a centralized Kubernetes orchestration system containing platform-specific knowledge for one or more managed Kubernetes platforms, including, without limitation, any one or more of VMware Tanzu, Google Kubernetes Engine (GKE), Amazon Elastic Kubernetes Service (EKS), Azure Kubernetes Service (AKS), Red Hat OpenShift, and Docker EE.

Kubernetes orchestration features disclosed herein enable IT administrators to manage not only the Kubernetes deployment itself, but also the configuration of the underlying cluster infrastructure, beneficially enabling centralized management of external Kubernetes clusters using automation with platform-specific tooling. Disclosed methods and systems support tasks including scaling the number and/or size of the cluster nodes up or down, upgrading the Kubernetes version, and adjusting user roles or permissions.

In one aspect, the teachings herein disclose a method for managing remote Kubernetes clusters on one or more managed Kubernetes platforms, e.g. AKS, GKE, Tanzu, etc., with a central orchestrator that includes a plurality of cluster integration interfaces for a corresponding plurality of managed platforms. Prior to invoking the central orchestrator, authentication has been configured for a cluster-admin role bound to a user in the customer organization. A managed Kubernetes platform associated with a remote Kubernetes cluster of interest is selected via one of the cluster integration interfaces. A connection with the managed Kubernetes platform is registered. The connection may include platform account credentials and cluster admin role information, i.e., information corresponding to the authenticated cluster-admin role. A platform-specific microservice (PSM) is then instantiated. The PSM is provisioned with platform-specific logic and tooling. The PSM is configured to connect to the managed Kubernetes platform and retrieve, from the managed Kubernetes platform, an administrative manifest, e.g., a YAML manifest, including one or more administrative artifacts, e.g., pods, services, etc., enabling the central orchestrator to communicate securely with the managed Kubernetes platform and deploy and manage application workloads on the cluster. The cluster of interest may then be imported into the central orchestrator, enabling cluster administrators to invoke the central orchestrator to perform platform-specific management tasks, including cluster infrastructure configuration tasks such as scaling nodes associated with the cluster, updating a Kubernetes version of the cluster, and modifying access/permission roles associated with the cluster. The method may be performed for clusters residing on one or more other managed Kubernetes platforms such that that the central orchestrator provides a single resource enabling cluster administrators to manage all of the customers remote clusters.

In another aspect, the teachings herein disclose an information handling system with a central orchestrator configured to manage remote Kubernetes clusters on one or more managed Kubernetes platforms. The central orchestrator includes a plurality of cluster integration interfaces for a corresponding plurality of managed platforms. Prior to invoking the central orchestrator, authentication has been configured for a cluster-admin role bound to a user in the customer organization. A managed Kubernetes platform associated with a remote Kubernetes cluster of interest is selected via one of the cluster integration interfaces. A connection with the managed Kubernetes platform is registered. The connection may include platform account credentials and cluster admin role information. A PSM provisioned with platform-specific logic and tooling is then instantiated. The PSM is configured to connect to the managed Kubernetes platform and retrieve, from the managed Kubernetes platform, an administrative manifest including one or more administrative artifacts that enable the central orchestrator to communicate securely with the managed Kubernetes platform and deploy and manage application workloads on the cluster. The central orchestrator may then import the cluster of interest to enable cluster administrators to perform platform-specific management tasks, including cluster infrastructure configuration tasks on the cluster. In this manner, the central orchestrator can import one or more clusters from two or more different managed

In accordance with subject matter disclosed in the following description, an information handling system includes

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a flow diagram of a method for managing clusters on one or more managed Kubernetes platforms in accordance with disclosed teachings;

FIG. 2 illustrates a system for managing clusters on one or more managed Kubernetes platforms in accordance with disclosed teachings; and

FIG. 3 illustrates an exemplary information handling system.

### DETAILED DESCRIPTION

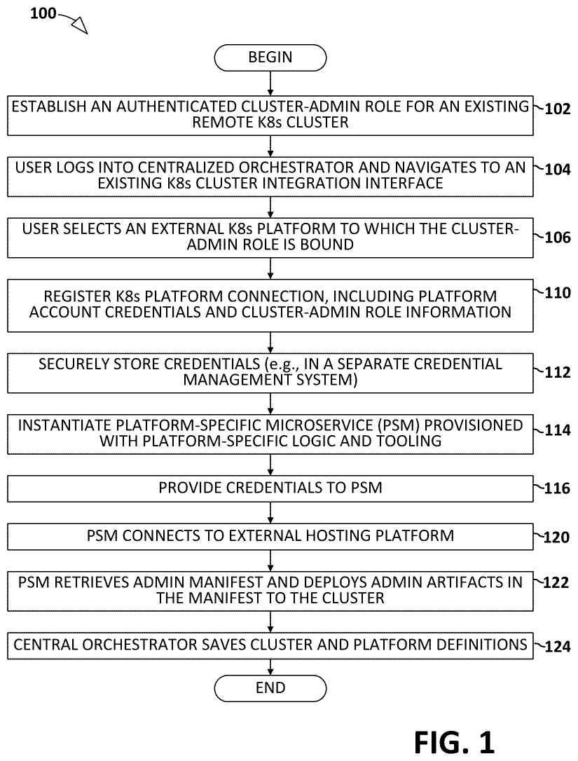

Exemplary embodiments and their advantages are best understood by reference to FIGS. 1-3, wherein like numbers are used to indicate like and corresponding parts unless expressly indicated otherwise.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”), microcontroller, or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

Additionally, an information handling system may include firmware for controlling and/or communicating with, for example, hard drives, network circuitry, memory devices, I/O devices, and other peripheral devices. For example, the hypervisor and/or other components may comprise firmware. As used in this disclosure, firmware includes software embedded in an information handling system component used to perform predefined tasks. Firmware is commonly stored in non-volatile memory, or memory that does not lose stored data upon the loss of power. In certain embodiments, firmware associated with an information handling system component is stored in non-volatile memory that is accessible to one or more information handling system components. In the same or alternative embodiments, firmware associated with an information handling system component is stored in non-volatile memory that is dedicated to and comprises part of that component.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically. Thus, for example, “device 12-1” refers to an instance of a device class, which may be referred to collectively as “devices 12” and any one of which may be referred to generically as “a device 12”.

As used herein, when two or more elements are referred to as “coupled” to one another, such term indicates that such two or more elements are in electronic communication, mechanical communication, including thermal and fluidic communication, thermal, communication or mechanical communication, as applicable, whether connected indirectly or directly, with or without intervening elements.

Referring now to the drawings, the flow chart of FIG. 1 illustrates a method 100 for managing as-a-service containerized deployments in accordance with disclosed subject matter. For the sake of clarity and brevity, method 100 is presented in the context of a Kubernetes as-a-service deployment. Those or ordinary skill in the field, however, will appreciate that disclosed teachings encompass alternative implementations.

The method 100 illustrated in FIG. 1 begins with the establishment (operation 102) of a cluster-admin role authenticated for the applicable provider-platform for an existing remote Kubernetes cluster. This operation, which binds the cluster-admin role to a user in the customer organization, may be performed out of band but, in at least some embodiments, must be established before other operations illustrated in FIG. 1 can be performed.

As depicted in FIG. 1, an IT administrator or other user logs into (operation 104) a centralized orchestrator system and navigates to a Kubernetes cluster integration section. The user then selects (operation 106) an external Kubernetes platform for which they have already bound the cluster-ad min role and from which they want to import an existing Kubernetes cluster. The user registers (operation 110) the Kubernetes platform connection. In at least some embodiments, this includes not only platform account credentials, but also cluster-admin role information for the Kubernetes deployment itself. The credentials are securely stored (operation 112) in a separate credential management system.

The method 100 illustrated in FIG. 1 instantiates (operation 114) a platform-specific microservice (PSM) provisioned with platform-specific logic and tooling and provides (operation 116) the previously-collected credentials to the PSM. The PSM then connects (operation 120) to the external hosting platform. Any platform-specific commands available to enable additional functionality for managing the Kubernetes environment will be leveraged where appropriate.

The PSM retrieves (operation 122) a Kubernetes manifest, referred to herein as an admin manifest, from a suitable formatted file, e.g., a YAML (yet another markup language) file. As suggested by its name, the admin manifest includes one or more administrative-management artifacts, e.g., pods, services, etc., some or all of which are deployed to the cluster. The admin artifacts enable secure communication with the centralized orchestrator and provide functionality to deploy and manage application workloads on the cluster from the centralized orchestrator. The cluster (and platform) definition is saved in the central orchestration system for access in the future as the user needs to interact with the cluster. After importing the external cluster, the user is free to deploy workloads to the cluster.

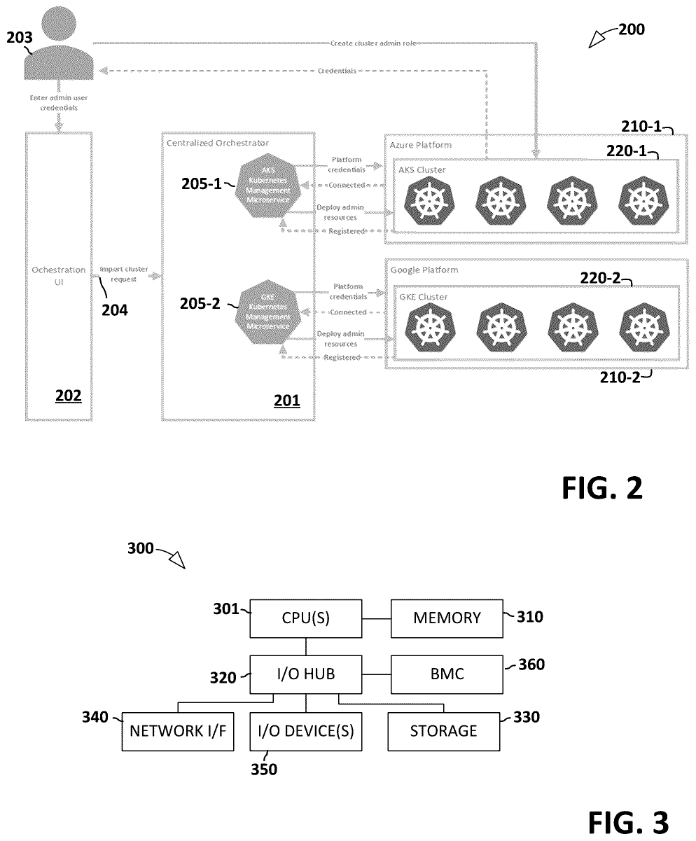

Referring now to FIG. 2, a central orchestrator 201 in accordance with disclosed teachings is illustrated within a cluster management system 200. The cluster management system 200 illustrated in FIG. 2 encompasses two managed Kubernetes platforms including an Azure platform 210-1 and a Google platform 210-2, but it will be appreciated that cluster management system 200 may integrate more and/or different managed Kubernetes platforms. Once the initial authentication and connection flow described in conjunction with FIG. 1 has been completed for one or more managed Kubernetes platforms 210, platform specific microservices clusters 220 from any one or more of the managed Kubernetes platforms 210 can be imported into central orchestrator 201 for cluster management.

The illustrated cluster management system 200 includes an orchestration user interface (OUI) 202 communicatively coupled to central orchestrator 201 and accessible to one or more administrative users 203. The OUI 202 of FIG. 2 includes features for displaying a list of managed clusters 220 and providing cluster import requests 204 to central orchestrator 201.

Each managed Kubernetes platform 210 may support a unique set of features and, in at least some embodiments, central orchestrator 201 enables, via one or more platform specific microservices 205, the applicable management features on the cluster's hosting platform will be appropriately enabled. For example, if Azure platform 210 is the hosting platform for a cluster of interest 220-1, then at least some AKS-specific features will be enabled for cluster 220-1 within central orchestrator 201. Accordingly, administrator 203 may employ central orchestrator 201 to invoke Azure-specific tools and resources to administer any Azure-hosted cluster, including the supporting infrastructure. Likewise, for Google-hosted clusters 220-2, at least some GKE-specific features would be enabled within central orchestrator 201 via OUI 202.

The illustrated cluster management system 200 beneficially requires no preexisting knowledge regarding any specific Kubernetes distribution. Accordingly, the illustrated cluster management system 200 comprises a centralized cluster manager that enables Kubernetes administrators to apply automated management to the virtualized infrastructure supporting the cluster. Additionally, cluster management system 200 allows for advanced intelligence such as auto scaling infrastructure nodes based on resource thresholds.

Referring now to FIG. 3, any one or more of the elements illustrated in FIG. 1 and FIG. 2 may be implemented as or within an information handling system exemplified by the information handling system 300 illustrated in FIG. 3. The illustrated information handling system includes one or more general purpose processors or central processing units (CPUs) 301 communicatively coupled to a memory resource 310 and to an input/output hub 320 to which various I/O resources and/or components are communicatively coupled. The I/O resources explicitly depicted in FIG. 3 include a network interface 340, commonly referred to as a NIC (network interface card), storage resources 330, and additional I/O devices, components, or resources 350 including as non-limiting examples, keyboards, mice, displays, printers, speakers, microphones, etc. The illustrated information handling system 300 includes a baseboard management controller (BMC) 360 providing, among other features and services, an out-of-band management resource which may be coupled to a management server (not depicted). In at least some embodiments, BMC 360 may manage information handling system 300 even when information handling system 300 is powered off or powered to a standby state. BMC 360 may include a processor, memory, an out-of-band network interface separate from and physically isolated from an in-band network interface of information handling system 300, and/or other embedded information handling resources. In certain embodiments, BMC 360 may include or may be an integral part of a remote access controller (e.g., a Dell Remote Access Controller or Integrated Dell Remote Access Controller) or a chassis management controller.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A method, comprising:
accessing a central orchestrator including a plurality of cluster integration interfaces for a corresponding plurality of managed platforms;
selecting, via one of the cluster integration interfaces, a managed Kubernetes platform associated with a remote Kubernetes cluster of interest;
registering a connection with the managed Kubernetes platform;
instantiating a platform-specific microservice (PSM) provisioned with platform-specific logic and tooling, wherein the PSM is configured to:
connect to the managed Kubernetes platform;
retrieve, from the managed Kubernetes platform, an administrative manifest including one or more administrative artifacts; and
deploy the administrative artifacts to the cluster to enable the central orchestrator to communicate securely with the managed Kubernetes platform and deploy and manage application workloads on the cluster; and
importing the cluster of interest into the central orchestrator; and
performing platform specific management tasks on the cluster of interest via the central orchestrator.

2. The method of claim 1, further comprising:
establishing, prior to selecting the managed Kubernetes platform, an authenticated cluster-admin role for the remote Kubernetes cluster.

3. The method of claim 1, wherein the connection with the managed Kubernetes platform includes platform account credentials and cluster admin role information corresponding to the authenticated cluster-admin role.

4. The method of claim 1, wherein the administrative manifest comprises a yet another markup language (YAML) file.

5. The method of claim 1, wherein the platform specific management tasks include cluster infrastructure configuration tasks.

6. The method of claim 5, wherein the cluster infrastructure configuration tasks include a task selected from:
scaling the number of nodes associated with the cluster of interest;
upgrading a Kubernetes version associated with the cluster of interest; and
adjusting user roles and user permissions associated with the cluster of interest.

7. The method of claim 1, further comprising:
saving a cluster definition to enable future accesses to the cluster.

8. The method of claim 1, wherein the plurality of managed platforms include one or more platforms selected from: VMware Tanzu, Google Kubernetes Engine (GKE), Amazon Elastic Kubernetes Service (EKS), Azure Kubernetes Service (AKS), Red Hat OpenShift, and Docker EE.

9. An information handling system, comprising:
a central processing unit (CPU); and
a memory, accessible to the CPU, including processor executable instructions that, when executed by the CPU, enable the system to perform operations including:
accessing a central orchestrator including a plurality of cluster integration interfaces for a corresponding plurality of managed platforms;
selecting, via one of the cluster integration interfaces, a managed Kubernetes platform associated with a remote Kubernetes cluster of interest;
registering a connection with the managed Kubernetes platform;
instantiating a platform-specific microservice (PSM) provisioned with platform-specific logic and tooling, wherein the PSM is configured to:
connect to the managed Kubernetes platform;
retrieve, from the managed Kubernetes platform, an administrative manifest including one or more administrative artifacts; and
deploy the administrative artifacts to the cluster to enable the central orchestrator to communicate securely with the managed Kubernetes platform and deploy and manage application workloads on the cluster;
importing the cluster of interest into the central orchestrator; and
performing platform specific management tasks on the cluster of interest via the central orchestrator.

10. The information handling system of claim 9, wherein the operations further include:
establishing, prior to selecting the managed Kubernetes platform, an authenticated cluster-admin role for the remote Kubernetes cluster.

11. The information handling system of claim 9, wherein the connection with the managed Kubernetes platform includes platform account credentials and cluster admin role information corresponding to the authenticated cluster-admin role.

12. The information handling system of claim 9, wherein the administrative manifest comprises a yet another markup language (YAML) file.

13. The information handling system of claim 9, wherein the platform specific management tasks include cluster infrastructure configuration tasks.

14. The information handling system of claim 13, wherein the cluster infrastructure configuration tasks include a task selected from:
scaling the number of nodes associated with the cluster of interest;
upgrading a Kubernetes version associated with the cluster of interest; and
adjusting user roles and user permissions associated with the cluster of interest.

15. The information handling system of claim 9, wherein the operations further include:
saving a cluster definition to enable future accesses to the cluster.

16. The information handling system of claim 9, wherein the plurality of managed platforms include one or more platforms selected from: VMware Tanzu, Google Kubernetes Engine (GKE), Amazon Elastic Kubernetes Service (EKS), Azure Kubernetes Service (AKS), Red Hat OpenShift, and Docker EE.
